(19) United States
(12) Patent Application Publication
(10) Pub. No.: US 2013/0127306 A1
(43) Pub. Date: May 23, 2013

(54) Furniture Including A Slidable Panel For Concealing A Display Stand

(71) Applicant: Gene Head, Winderemere, FL (US)

(72) Inventor: Gene Head, Winderemere, FL (US)

(21) Appl. No.: 13/656,034

(22) Filed: Oct. 19, 2012

Related U.S. Application Data
(60) Provisional application No. 61/549,041, filed on Oct. 19, 2011.

(51) Int. Cl. A47B 88/22; E05D 13/00; A47B 81/06

(52) U.S. Cl. CPC A47B 88/22; A47B 81/06; E05D 13/10
USPC 312/7.2; 312/204; 312/319.4

(57) ABSTRACT

Furniture including a means for concealing a display stand and an object affixed thereto, such as a television. The furniture includes an upper housing and a lower housing, such as a dresser-hutch combination. A panel, such as a framed mirror that is part of the upper housing, conceals the display stand when in an ascended position. The panel vertically slides down into the lower housing in order to expose the display stand upon manipulation by the user's hand. Controlled sliding with the appropriate tension is provided by use of a counterbalance system in combination with a sliding track system.

This application claims the benefit of U.S. Provisional Application No. 61/549,041, filed Oct. 19, 2011, the disclosure of which is expressly incorporated herein by reference.

### BACKGROUND OF THE INVENTION

The present invention is directed towards an item of furniture including a slidable panel for concealing a display stand, such as a display stand for a flat screen television. The purpose of this invention is to provide an economical and aesthetically pleasing means of concealing the display stand within the item of furniture.

One prior art attempt at concealing a display stand within an item of furniture has included an electrically motorized lift for lifting and descending either the display stand or a mirror that covers the display stand, which is very expensive and difficult to manufacture and maintain.

The present invention overcomes the noted deficiencies in the prior art by providing an item of furniture wherein a display stand is concealed by a mechanical, vertically slidable panel that is easily moved by the user.

### SUMMARY OF THE INVENTION

The present invention is an item of furniture including an upper housing, a lower housing, a display stand that resides in the upper housing, and a panel that vertically slides between an ascended position in the upper housing and a descended position in the lower housing. When the panel is in the ascended position, the panel substantially conceals the display stand as viewed from the front of the furniture, and when the panel is in the descended position, the display stand is substantially exposed as viewed from the front of the furniture.

The panel mechanically slides between the ascended position and the descended position upon physical manipulation by a user. At least one sliding track system is affixed to the panel and an interior of the upper housing to facilitate the panel sliding between the ascended position and the descended position. The sliding track system may be a telescoping slide system or a linear motion slide.

A counterbalance system is provided that facilitates controlled sliding of the panel between the ascended position and the descended position. In one embodiment, the counterbalance system includes at least one counterbalance weight, at least one cable, and at least one pulley. The counterbalance weight counterbalances the weight of the panel, the pulley is affixed to an interior of the upper housing, and the cable is affixed to the counterbalance weight and the panel.

In another embodiment, the counterbalance system includes a spiral balance torsion spring system consisting of a at least one tube and at least one spiral rod. The tube is affixed to either the panel or an interior of the upper housing, and the rod is affixed to the other of the panel or interior of the upper housing.

In a further embodiment, the counterbalance system is a block and tackle counterbalance system including at least one hook, at least one cable, and at least one traveling block. The hook is affixed to either the panel or an interior of the upper housing, the traveling block is affixed to the other of the panel or the upper housing, and the cable is affixed to the hook and the traveling block.

In yet another embodiment, the counterbalance system is a constant force coil spring system including at least one coil and at least one tape. The coil is affixed to either the panel or an interior of the upper housing, and the tape is affixed to the other of the panel or the upper housing.

The display stand is stationary in the furniture in embodiments of the present invention and is configured for attachment to a television.

In one embodiment, the furniture is a combination of a dresser and a mirrored hutch such that the upper housing is the mirrored hutch and the lower housing is the dresser. In another embodiment, the furniture is an entertainment unit. Additionally, the upper housing and lower housing may form a unitary case piece.

In yet a further embodiment, the upper housing is formed by a first portion and a second portion, and wherein a position of the second portion relative to the first portion is adjustable in order to adjust a depth of the upper housing. Also, the upper housing may be configured for attachment to the lower housing such that a rear panel of the upper housing overhangs a rear panel of the lower housing.

The present invention is further directed towards an item of furniture including a display stand that resides in the furniture, a panel that mechanically and vertically slides between an ascended position and a descended position in the furniture upon physical manipulation by a user, and a counterbalance system that facilitates controlled sliding of the panel between the ascended position and the descended position. When the panel is in the ascended position, the panel substantially conceals the display stand as viewed from the front of the furniture, and when the panel is in the descended position, the display stand is substantially exposed as viewed from the front of the furniture. The counterbalance system may be a counterbalancing weight and pulley system, a spiral balance torsion spring system, a block and tackle system, or a constant force coil spring system.

### BRIEF DESCRIPTION OF THE DRAWINGS

The foregoing, as well as other objects of the present invention, will be further apparent from the following detailed description of the preferred embodiment of the invention, when taken together with the accompanying specification and the drawings, in which:

FIG. 1 is a perspective view of a dresser and mirrored hutch combination with a panel in a fully ascended position in accordance with an embodiment of the present invention.

FIG. 2 is a perspective view of the dresser and mirrored hutch combination of FIG. 1 with the panel descending into the lower housing in accordance with an embodiment of the present invention.

FIG. 3 is a perspective view of an entertainment unit with a panel in a fully ascended position in accordance with an embodiment of the present invention.

FIG. 4 is a perspective view of the entertainment unit of FIG. 3 with the panel fully descended into the lower housing of the entertainment unit in accordance with an embodiment of the present invention.

FIG. 5A is a side view of a dresser and mirrored hutch combination with the mirror in a fully ascended position and showing the counterweights disposed within the furniture in accordance with an embodiment of the present invention.

FIG. 5B is a side view of the dresser and mirrored hutch combination of FIG. 5A with the mirror in a fully descended position and showing the counterweights disposed within the furniture in accordance with the present invention.

FIG. 6 is a perspective front view of the dresser and mirrored hutch combination of FIG. 5A with the mirror in a fully ascended position and showing the counterweights disposed within the furniture in accordance with an embodiment of the present invention.

FIG. 7 is a perspective front view of the dresser and mirrored hutch combination of FIG. 5A with the mirror descending into the dresser in accordance with the present invention.

FIG. 8 is a perspective front view of the dresser and mirrored hutch combination of FIG. 5A with the mirror fully descended into the dresser in accordance with the present invention.

FIG. 9 is a perspective rear view of a dresser and mirrored hutch combination with the mirror in a fully ascended position and showing the spiral balance system in a compressed state in accordance with an embodiment of the present invention.

FIG. 10 is a perspective rear view of the dresser and mirrored hutch combination of FIG. 9 with the mirror descending into the dresser and showing the spiral balance system in an expanding state in accordance with an embodiment of the present invention.

FIG. 11 is perspective rear view of the dresser and mirrored hutch combination of FIG. 9 with the mirror in a fully descended position and showing the spiral balance system in a fully expanded state in accordance with an embodiment of the present invention.

FIG. 12 is a perspective rear view of a dresser and mirrored hutch combination with the mirror in a fully ascended position and showing a block and tackle system in a compressed state in accordance with an embodiment of the present invention.

FIG. 13 is a perspective rear view of the dresser and mirrored hutch combination of FIG. 12 with the mirror in a fully descended position and showing the block and tackle system in a fully expanded state in accordance with an embodiment of the present invention.

FIG. 14 is a perspective rear view of a dresser and mirrored hutch combination with the mirror in a fully ascended position and showing a constant force spring system in accordance with an embodiment of the present invention.

FIG. 15 is a perspective rear view of the dresser and mirrored hutch combination of FIG. 14 with the mirror in a fully descended position and showing a constant force spring system in accordance with an embodiment of the present invention.

FIG. 16 is a perspective rear view of a dresser and mirrored hutch combination having a single case piece forming the upper housing and lower housing in accordance with an embodiment of the present invention.

FIGS. 17A-17B are perspective rear views of a dresser and mirrored hutch combination wherein the case piece for the upper housing is expandable in accordance with an embodiment of the present invention.

FIG. 18 is a rear perspective view of a dresser and mirrored hutch combination including an upper housing that overhangs the lower housing in accordance with am embodiment of the present invention.

FIG. 19A is a perspective view of a linear motion slide.

FIG. 19B is a perspective view of a telescoping slide.

### DESCRIPTION OF THE PREFERRED EMBODIMENTS

The accompanying drawings and the description which follows set forth this invention in its preferred embodiments. However, it is contemplated that persons generally familiar with furniture design will be able to apply the novel characteristics of the structures illustrated and described herein in other contexts by modification of certain details. Accordingly, the drawings and description are not to be taken as restrictive on the scope of this invention, but are to be understood as broad and general teachings.

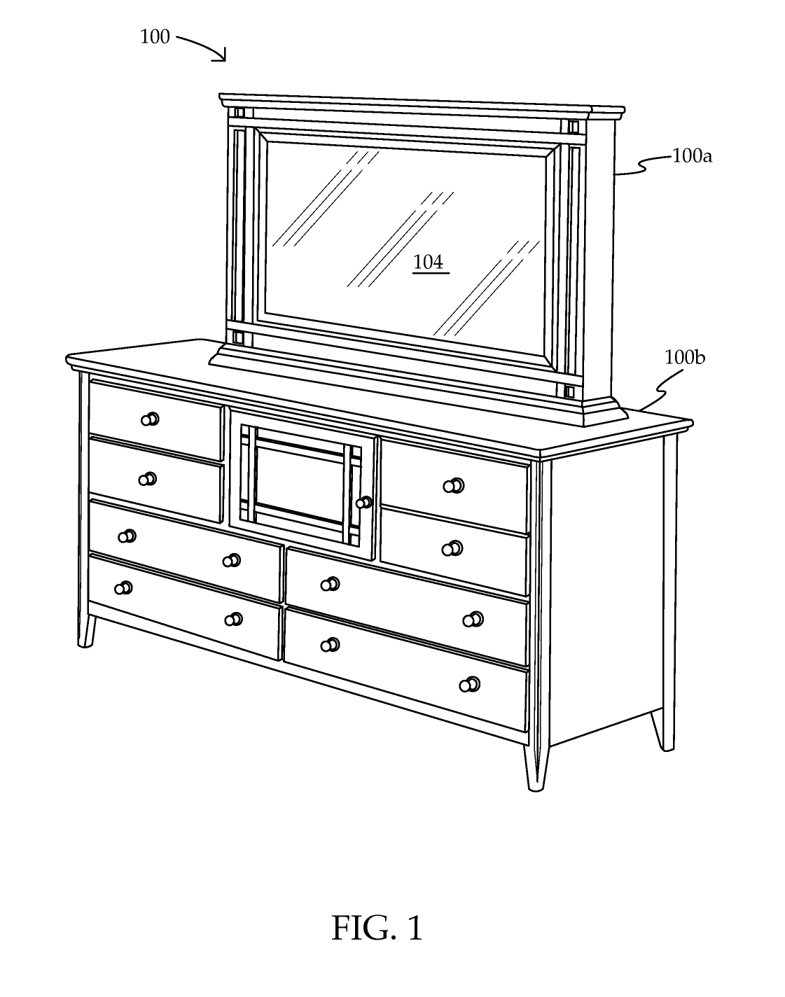

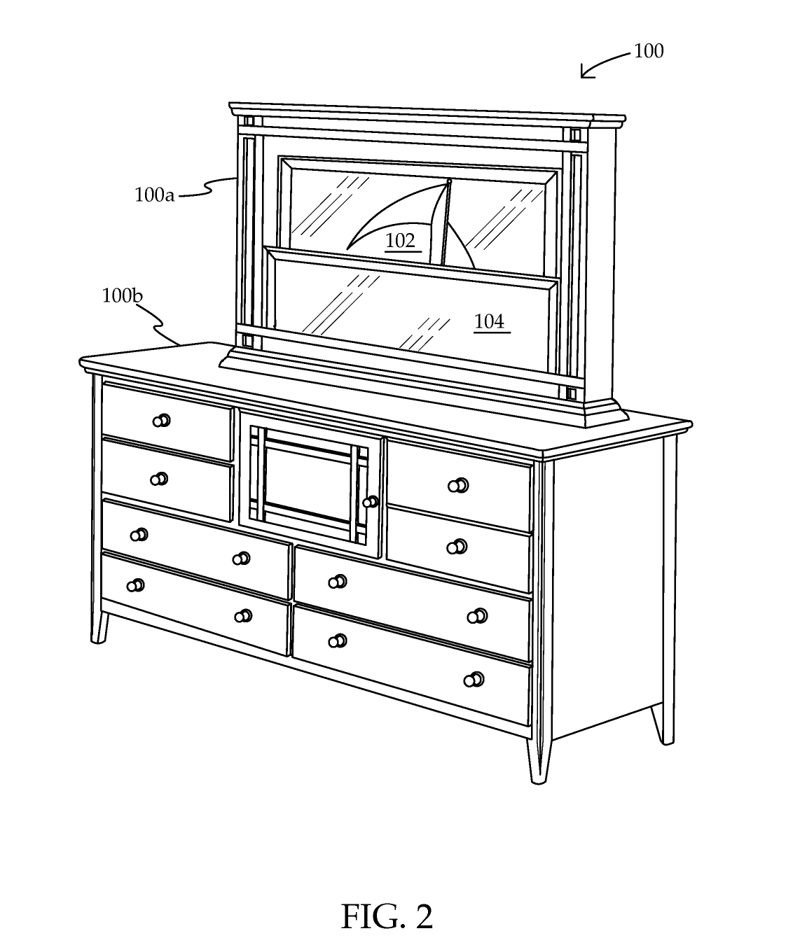

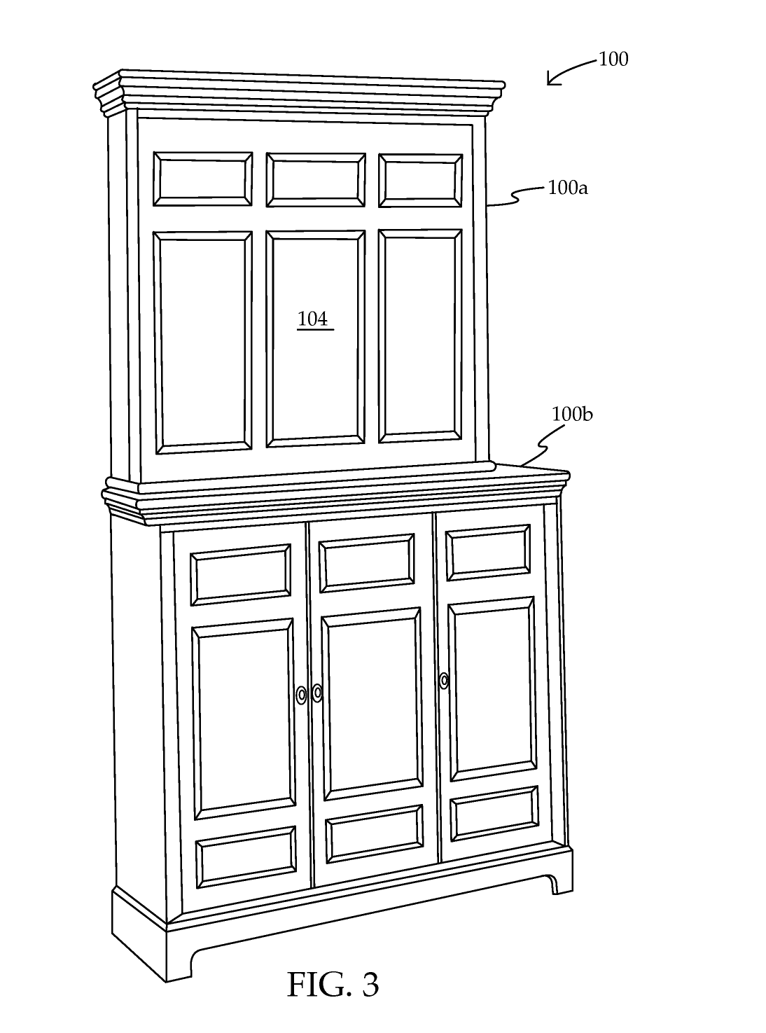

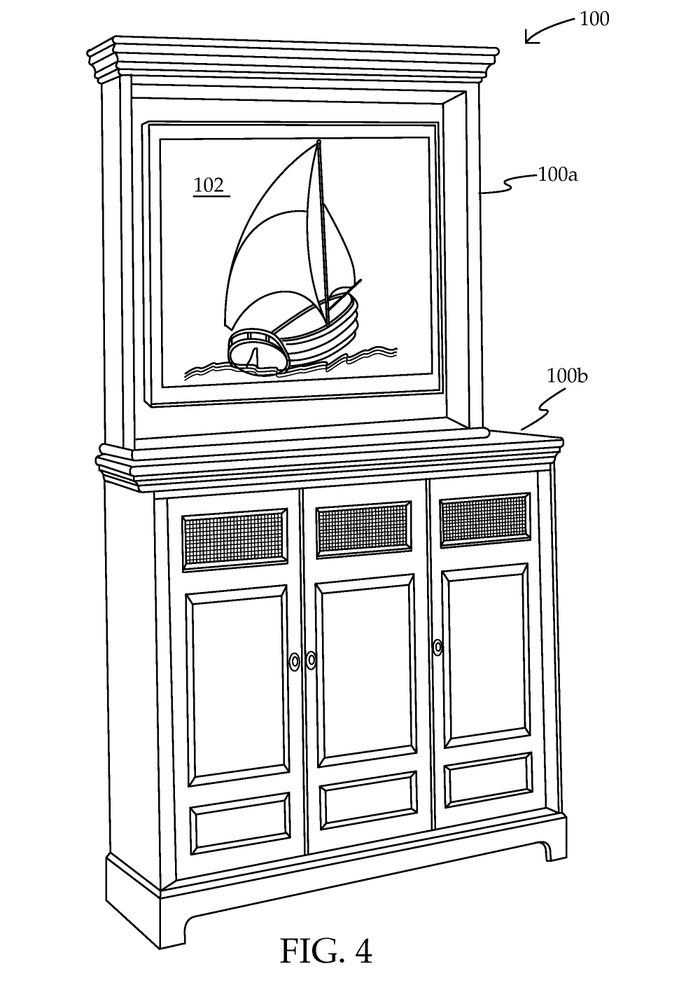

As shown in the Figures, the present invention is directed towards an item of furniture 100 having an upper housing 100a and a lower housing 100b, such as the dresser-mirrored hutch combination shown in FIGS. 1 and 2 or the entertainment unit shown in FIGS. 3 and 4. A display stand 102 resides in the upper housing 100a and is configured for attachment to an item to be displayed such as a television and, more particularly, a flat screen television. In embodiments of the present invention, the display stand 102 remains stationary within the upper housing 100a so that the television and its cables, for example, do not have to move within the furniture.

The furniture of the present invention further includes a panel 104 that is configured to conceal the display stand 102 as desired by the user. As shown in FIGS. 1 and 2, the panel 104 may be a framed mirror that is part of the hutch (upper housing 100a) of the dresser-mirrored hutch combination. As shown in FIG. 3, the panel 104 portion of the hutch (upper housing 100a) may be designed to match the facing of the entertainment unit's doors and/or drawers, to give the unit more of an armoire-look.

In embodiments of the present invention, the panel 104 is configured to vertically slide between the upper housing 100a and lower housing 100b of the furniture 100 to conceal or expose the display stand 102 as desired by the user. As shown in FIGS. 1 and 2, when the panel (e.g., mirror) 104 is in the fully ascended position in the upper housing 100a, the panel 104 completely conceals the display stand 102 behind it. When the panel 104 descends into the cavity of the lower housing 100b (e.g., dresser), it reveals or exposes the display stand 102 and the item attached thereto, such as a flat screen television.

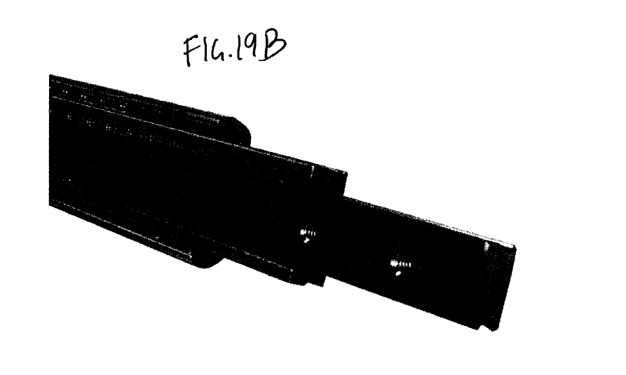

A pair of known sliding track systems is provided to enable the panel 104 to vertically slide between the ascended position in the upper housing 100a and the descended position in the lower housing 100b of the furniture 100. Each sliding track system may comprise a telescoping track (such as a full-extension ball bearing slide) as shown in FIG. 19A or non-telescoping track such as a linear motion slide as shown in FIG. 19B. The sliding track systems may be formed of any suitable material capable of withholding the weight of the panel 104.

In one embodiment, a fixed member of each sliding track system is affixed to either the panel 104 or the interior cavity of the upper housing 100a. The corresponding sliding member of each sliding track system is affixed to the other of the panel 104 or the interior cavity of the upper housing 100a. It is noted that the present invention is not limited to an exact location in the cavity of the upper housing 100a where the sliding track system is affixed. For example, the sliding track system may be affixed to each side of the interior cavity of the upper housing 100a, or may be affixed the interior cavity of the upper housing 100a behind the front molding (posts) of the upper housing 100a.

In another embodiment of the present invention, a two-part track may be used wherein the upper track is affixed to the interior cavity of the upper housing 100a and the lower track is affixed to the interior cavity of the lower housing 100b. In this embodiment, the track members on each side of the panel 104 line up with one another so the panel (e.g., mirror) 104 evenly slides up and down.

Irrespective of the particular type of sliding track system utilized, the panel 104 is configured to ascend and descend between the upper housing 100a and lower housing 100b of the furniture 100 with enough tension that prevents the panel 104 from forcefully transitioning from one position to the other, yet light enough tension that the panel 104 is easily moved by the user when he or she uses his or her hand to lightly pull the panel 104 up or down. This appropriate amount of tension is achieved by use of a counterbalance (or sometimes called counterweight) system. In its simplest form, a counterbalance system incorporates forces or weights that act to balance one another. Some known counterbalance systems include: (1) counterbalancing weights used in connection with cables and pulleys; (2) spiral balance torsion springs; (3) block and tackle balances; and (4) constant force coil springs.

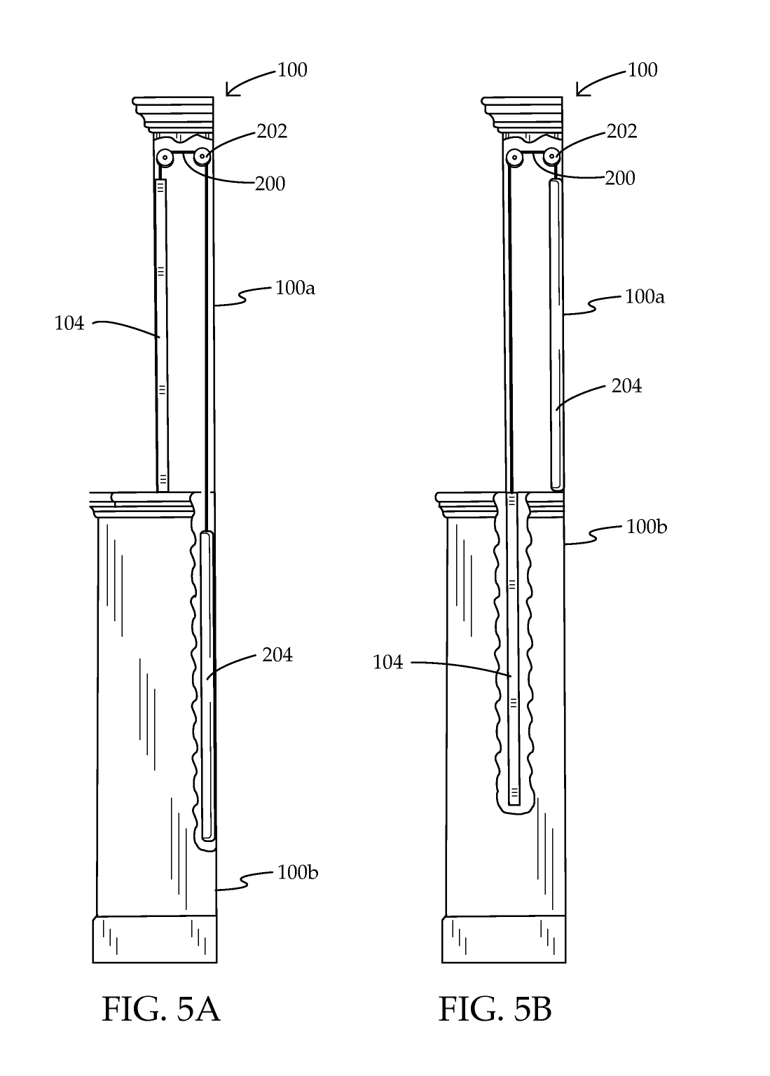

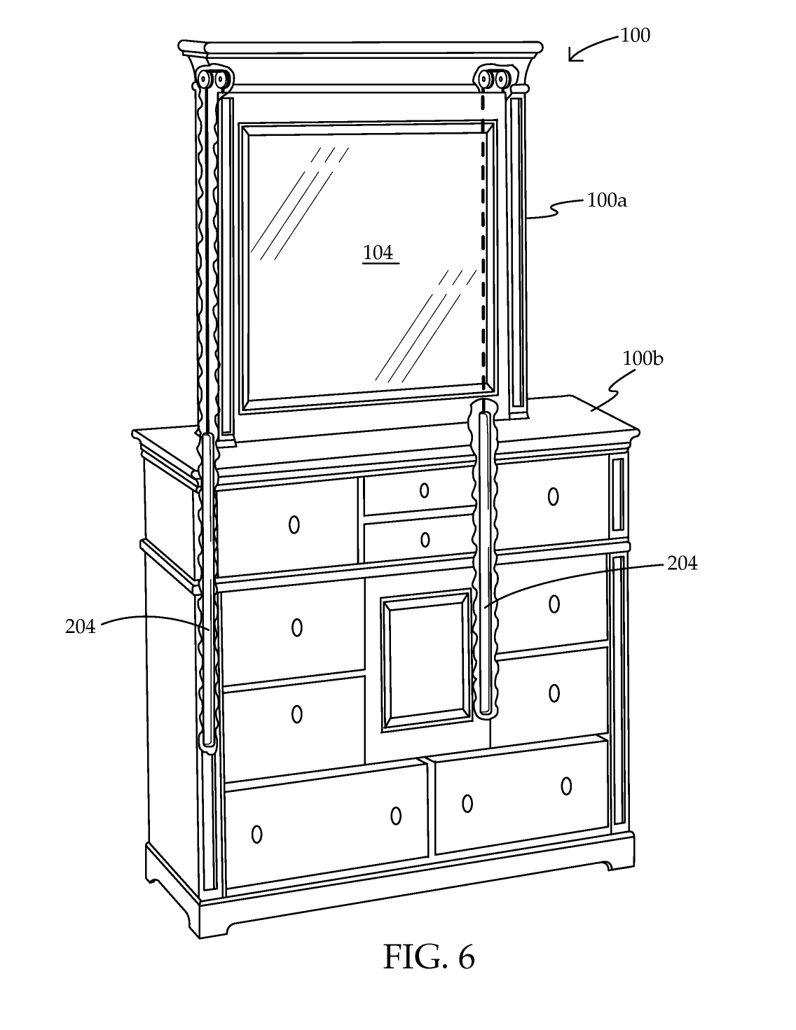

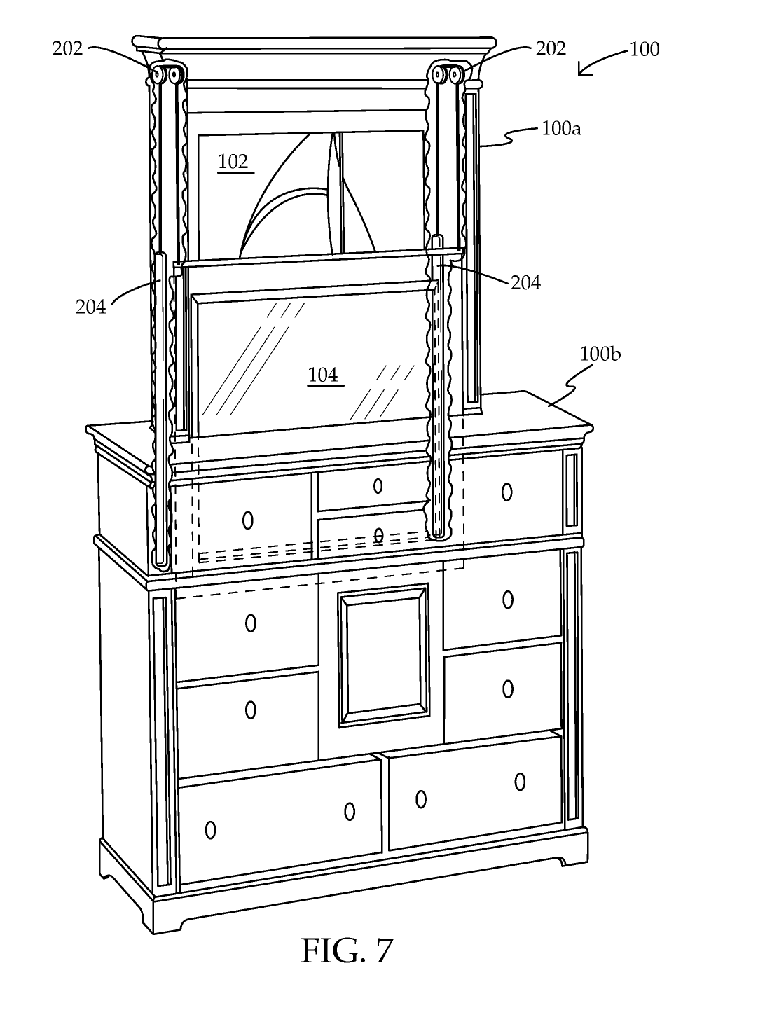

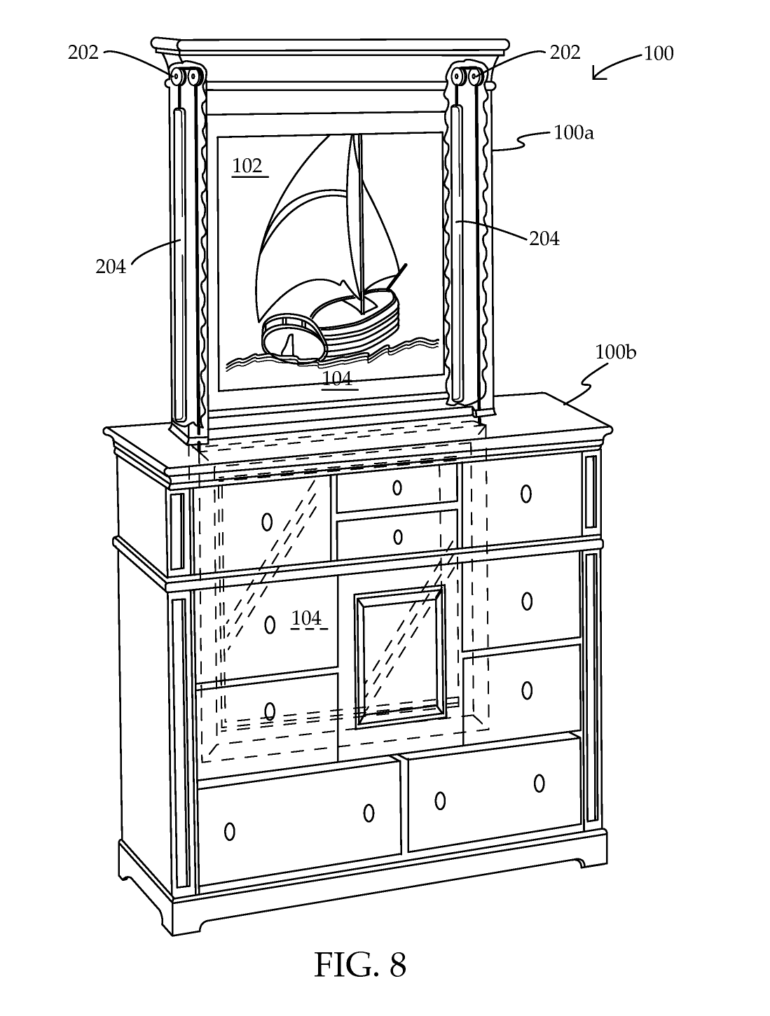

As shown in FIGS. 5-8, a pulley system with counterbalancing weights is used to facilitate controlled, vertical sliding of the panel 104. Particularly, cables 200 are attached to the panel (e.g., mirror) 104 and to counterbalancing weights 204, and the cables 200 are run over a system of pulleys 202 in the top of the interior cavity of the upper housing 100a. The weights 204 counterbalance the weight of the panel (e.g, mirror) 104 to provide controlled sliding of the panel 104 between its ascended and descended positions.

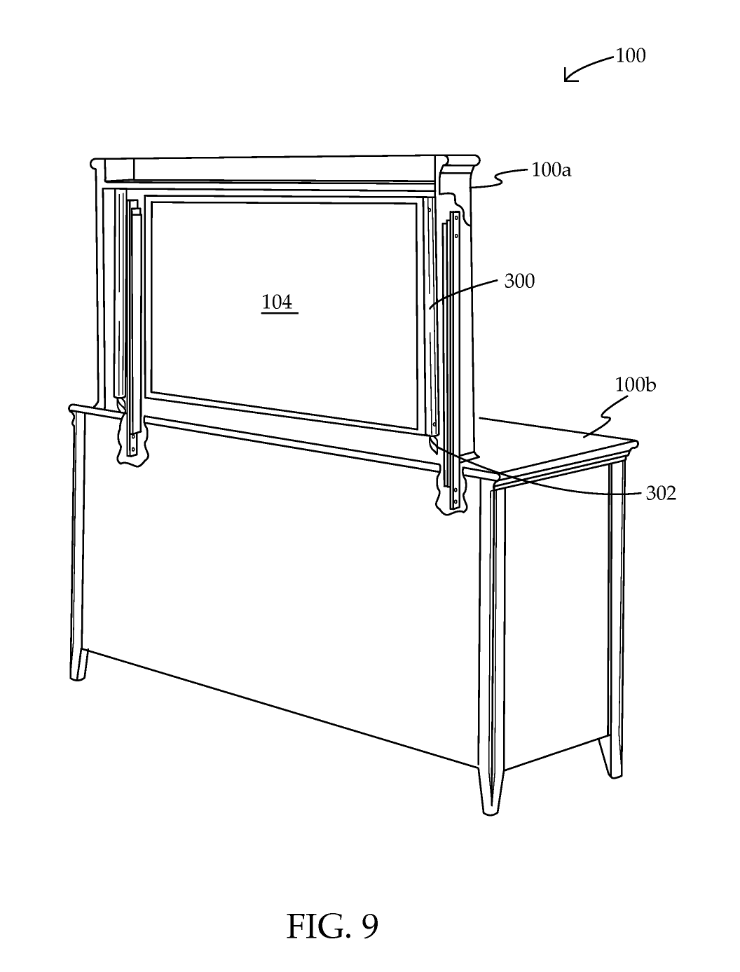

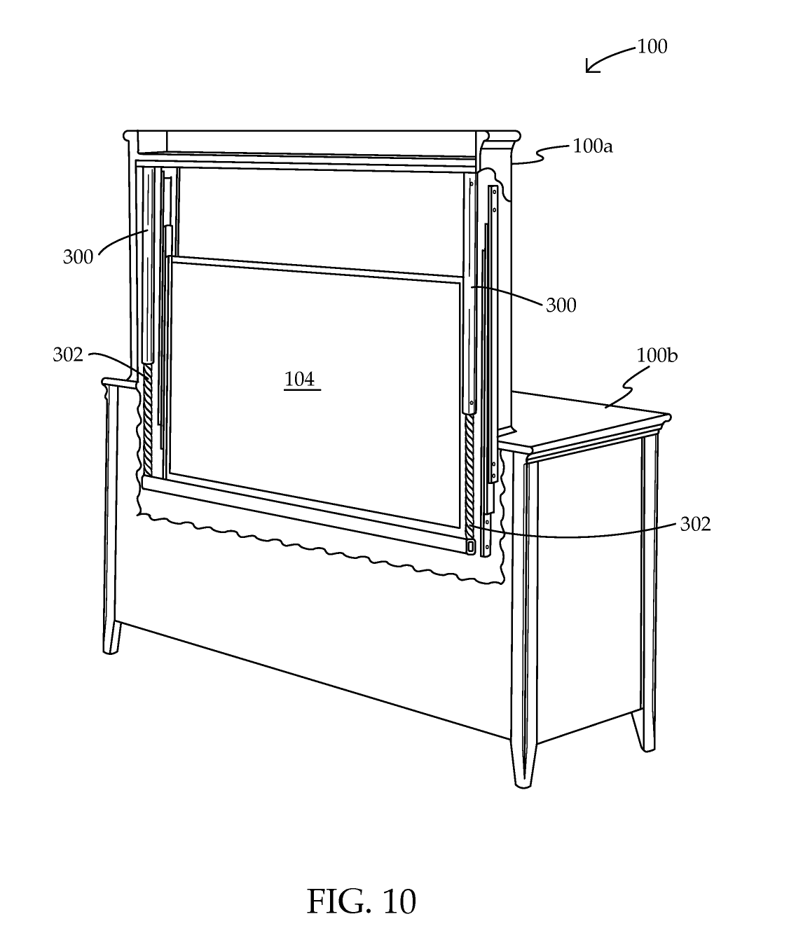

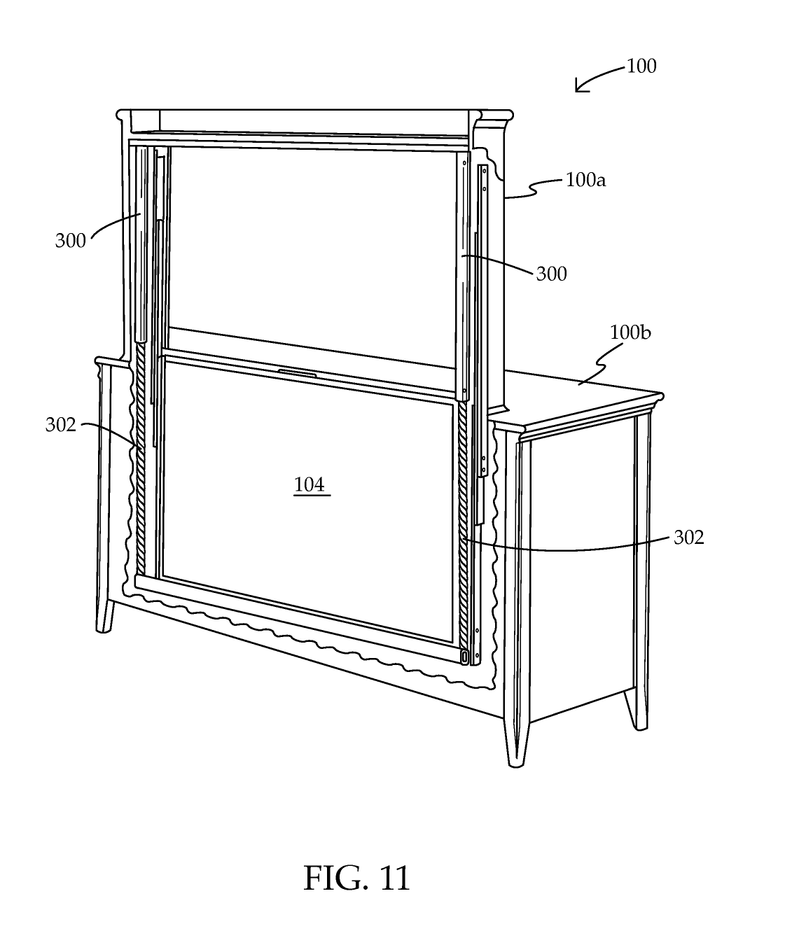

As shown in FIGS. 9-11, a spiral balance torsion spring system is used to facilitate controlled, vertical sliding of the panel 104. Known spiral balance systems include a tube and corresponding spiral rod. When used in the present invention, either the tube 300 or spiral rod 302 is affixed to the panel 104 (on the top, side, or rear of the panel) and the other of the corresponding tube 300 or spiral rod 302 is affixed to the interior cavity of the upper housing 100a. In the embodiment shown in the Figures, the tubes 300 are affixed to the interior cavity of the upper housing 100a and the corresponding spiral rods 302 are affixed to the panel (e.g., mirror) 104.

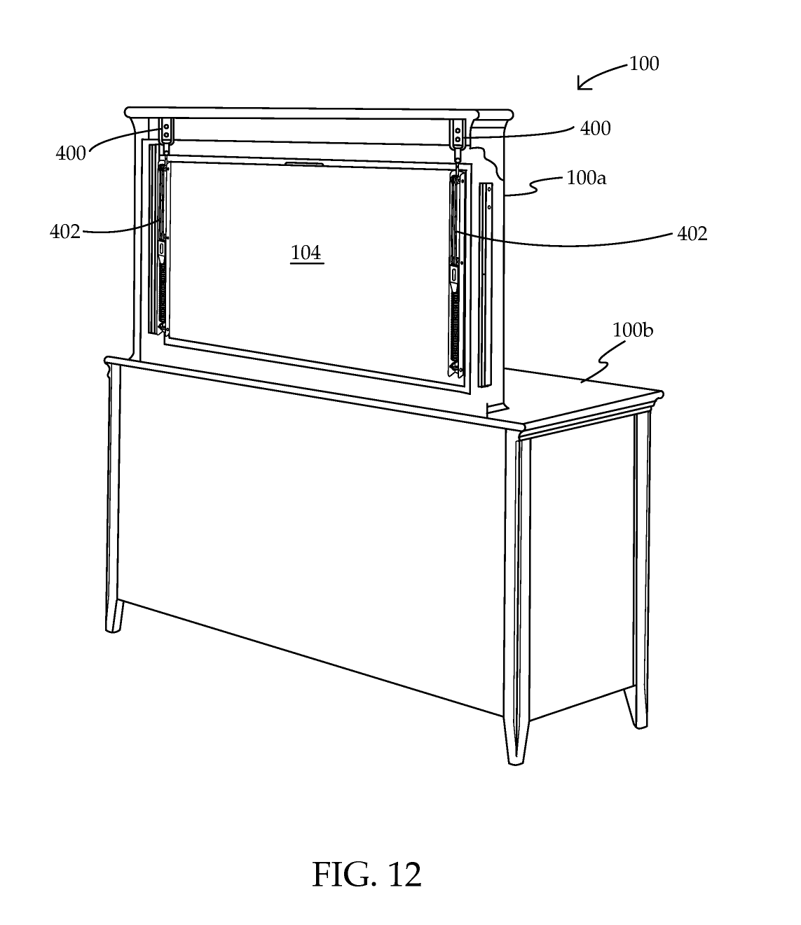

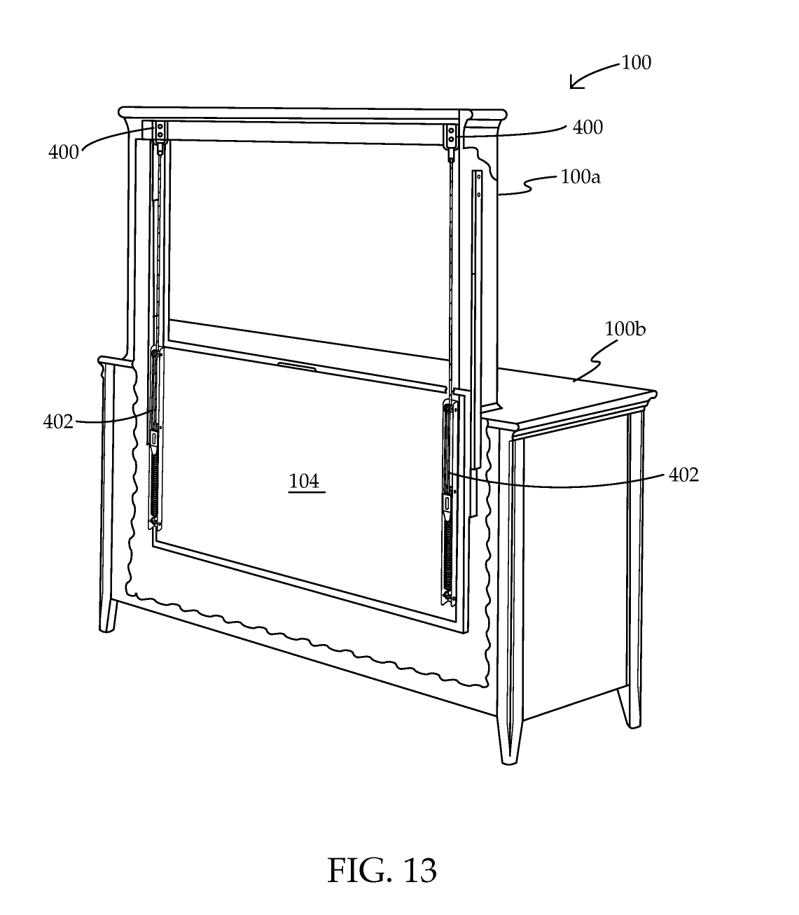

As shown in FIGS. 12-13, a block and tackle counterbalance system is used to facilitate controlled, vertical sliding of the panel. Known block and tackle counterbalance systems include a cable connected to a hook and a corresponding traveling block. When used in the present invention, either the hook 400 or traveling block 402 is affixed to the panel 104 (on the top, side, or rear of the panel) and the other of the corresponding hook 400 or traveling block 402 is affixed to the interior cavity of the upper housing 100a. In the embodiment shown in the Figures, the hooks 400 are affixed to the interior cavity of the upper housing 100a and the corresponding traveling blocks 402 are affixed to the panel (e.g, the mirror) 104. Cables 404 connect the respective hooks 400 and traveling blocks 402.

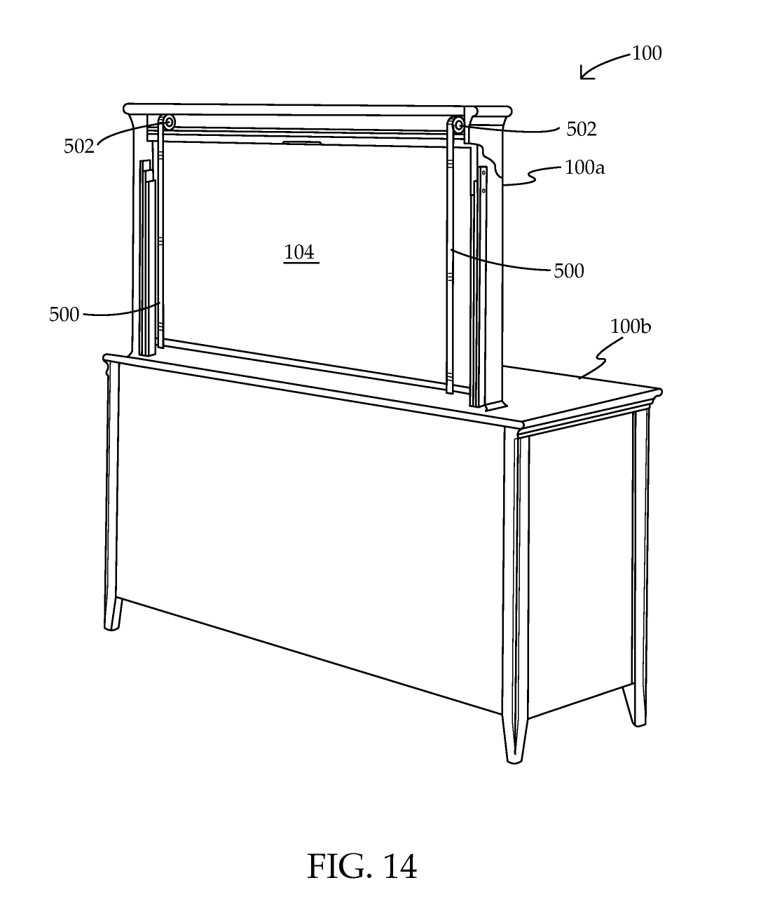

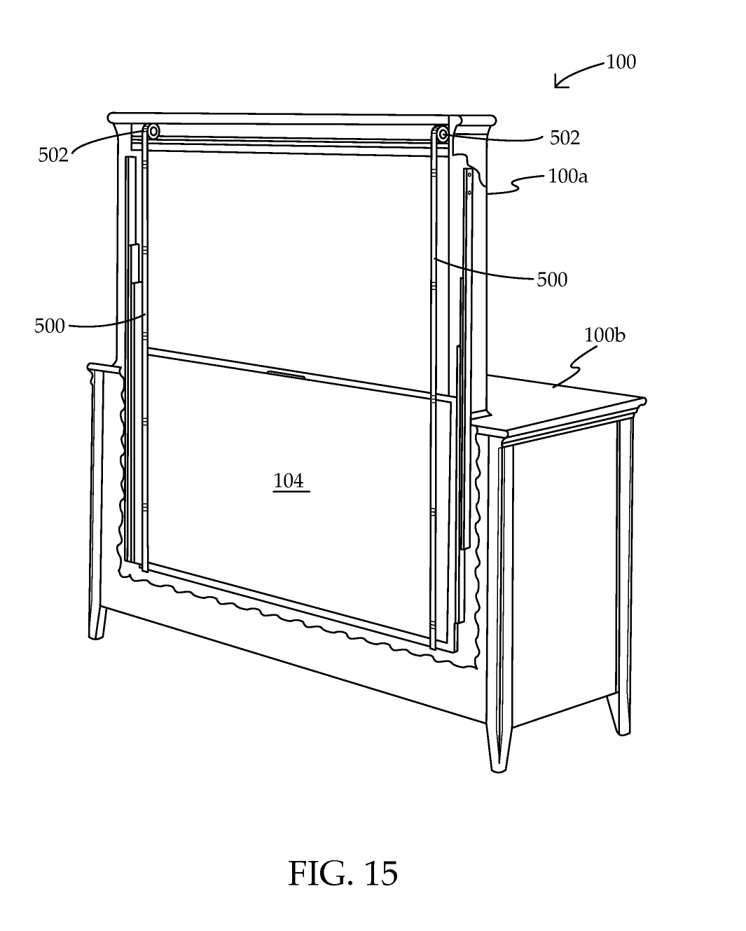

As shown in FIGS. 14-15, a constant force coil spring system is used to facilitate controlled, vertical sliding of the panel. Known constant force coil spring systems include a coil and a tape. When used in the present invention, either the tape 500 or the coil 502 is affixed to the panel 104 (on the top, side, or rear of the panel) and the other of the corresponding tape 500 or coil 502 is affixed to the interior cavity of the upper housing 100a. In the embodiment shown in the Figures, the coils 502 are affixed to the interior cavity of the upper housing 100a and the corresponding tapes 500 are affixed to the panel (e.g., mirror) 104.

It is noted that in the embodiments of the present invention described above, the portion of the counterbalance system that is affixed to the interior cavity of the upper housing 100a is not limited to a specific location in such interior cavity. The optimal position for the counterbalance system may depend, for example, on which type of counterbalance is being used. In some embodiments, the counterbalance system could be affixed to the top or sides of the interior cavity and, in other embodiments, the counterbalance system could be affixed to the back of the upper housing's 100 posts (front facing molding).

It is additionally noted that any appropriate counterbalance system may be incorporated into the present invention for the purpose of providing the appropriate amount of tension for the panel 104 to ascend and descend between the upper housing 100a and lower housing 100b, and the present invention is not limited to use of the counterbalance systems expressly disclosed herein. Further, other mechanical means for vertically sliding the panel 104 may be provided, such as a mechanically operated pneumatic lift.

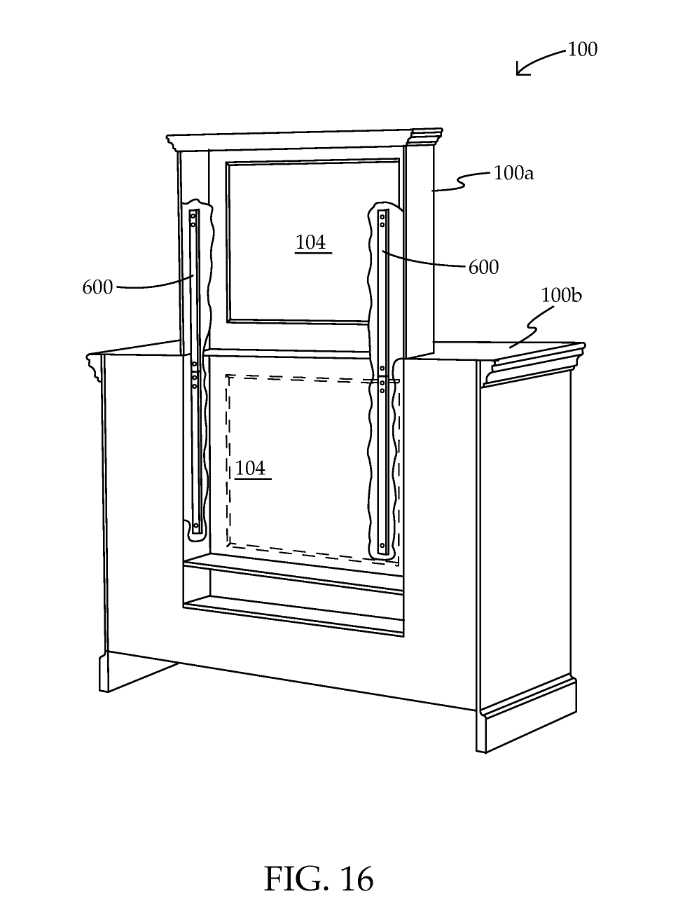

As shown in FIGS. 1 and 2, separate case pieces may be utilized for the furniture's 100 upper housing 100a (mirrored hutch) and lower housing 100b (dresser). Alternatively, as shown in FIG. 16, the upper housing 100a and lower housing 100b of the item of furniture 100 may be formed by a unitary case piece 600 that is inserted into a cutout in the back of the furniture 100. This embodiment enables the use of a unitary (non-telescoping) track system on each side of the sliding panel 104. In either embodiment, the lower housing 100b must be large enough to accommodate the depth and width of the panel 104 to reside within it when the panel 104 is in the fully descended position.

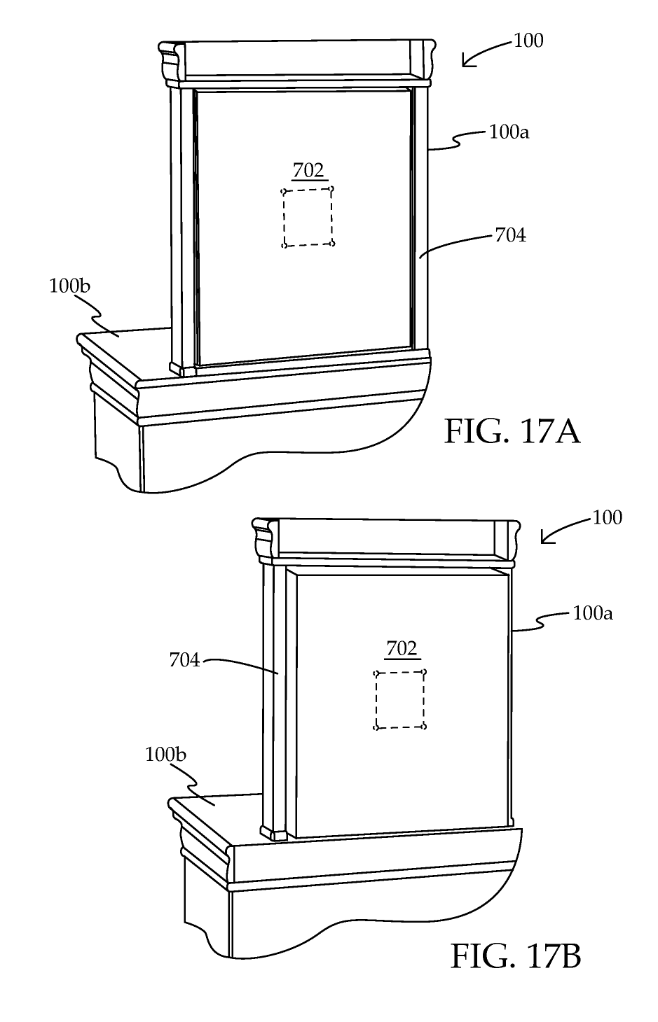

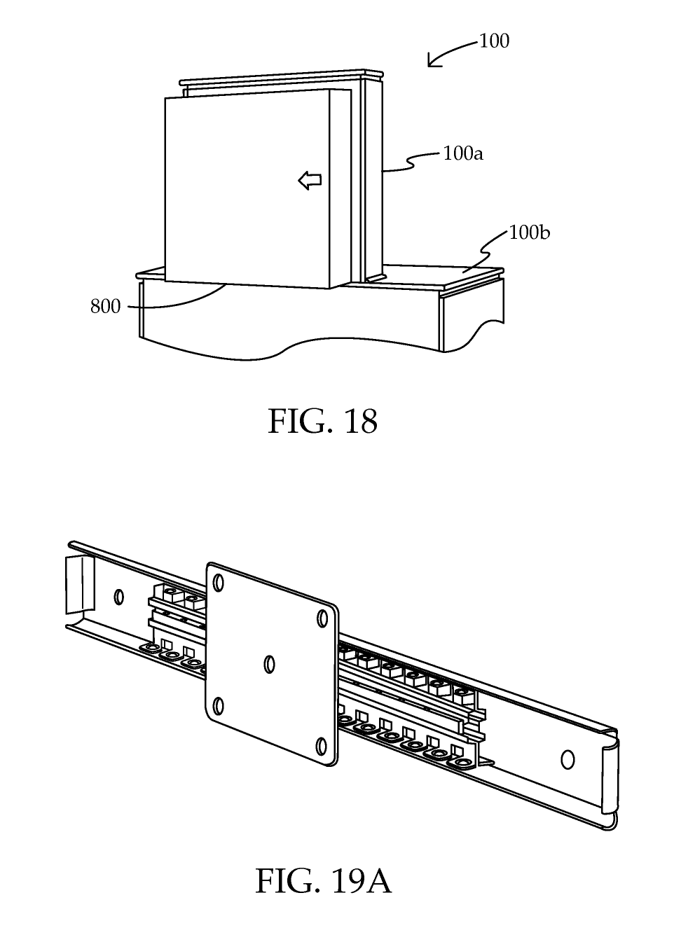

In the embodiment shown in FIGS. 17A and 17B, the depth of the upper housing 100a may be expandable or contractible by being formed of concentric box-like structures such that the inner box 702 fits within the outer box 704, and the inner box 702 may be pushed out to provide more space in the upper housing 100a for a thicker television, for example. In an alternative embodiment, as shown in FIG. 18, the upper housing 100a may be a case piece that is configured for attachment to the lower housing 100b such that a rear panel of the upper housing overhangs 800 the rear panel of the lower housing 100a. This gives the display stand 102 the aesthetically pleasing perspective of having a slim profile when affixed to a very thin television, for example.

Based on the foregoing, the present invention includes an item of furniture having an upper housing 100a and a lower housing 100b, and a panel 104 that mechanically and vertically slides between the upper housing and lower housing to conceal or expose a display stand. Controlled, vertical sliding of the panel is provided by use of a counterbalance system in combination with a sliding track system that enables the panel 104 to ascend and descend with enough tension to provide controlled sliding yet light enough tension that the panel 104 is easily slid by the user with hand manipulation.

In the above-described embodiments, the furniture 100 may include molding and trim to cover the sliding track and counterbalance systems used to facilitate sliding of the panel 104. As the panel 104 descends into the lower housing 100b, the item on the display stand 102, such as a flat screen television, is exposed for viewing. It is noted, however, that the present invention is not limited to the display stand 102 holding a television. Rather, it could also be used to hold other items such as jewelry or artwork. Additionally, the present invention is not limited to the panel 104 descending in order to reveal the display stand. In some embodiments, the furniture 100 could be designed such that the panel 104 is raised to reveal the display stand 102.

The present invention, as described above, provides a cost-efficient manner for manufacturing an item of furniture that slidably conceals a display stand and may be incorporated into a symmetrical design, which is more appealing than asymmetrical designs to consumers desiring traditionally-styled furniture.

While preferred embodiments of the invention have been described using specific terms, such description is for present illustrative purposes only, and it is to be understood that changes and variations to such embodiments, including but not limited to the substitution of equivalent features or parts, and the reversal of various features thereof, may be practiced by those of ordinary skill in the art without departing from the spirit or scope of the present disclosure.

What is claimed is:

1. Furniture comprising:
an upper housing;
a lower housing;
a display stand that resides in the upper housing; and
a panel that vertically slides between an ascended position in the upper housing and a descended position in the lower housing;
wherein when the panel is in the ascended position, the panel substantially conceals the display stand as viewed from the front of the furniture; and
wherein when the panel is in the descended position, the display stand is substantially exposed as viewed from the front of the furniture.

2. The furniture of claim 1 wherein the panel mechanically slides between the ascended position and the descended position upon physical manipulation by a user.

3. The furniture of claim 1, further comprising at least one sliding track system that is affixed to the panel and an interior of the upper housing to facilitate the panel sliding between the ascended position and the descended position.

4. The furniture of claim 2 wherein the sliding track system is selected from the group consisting of a telescoping slide system and a linear motion slide.

5. The furniture of claim 2, further comprising a counterbalance system that facilitates controlled sliding of the panel between the ascended position and the descended position.

6. The furniture of claim 5 wherein the counterbalance system comprises at least one counterbalance weight, at least one cable, and at least one pulley.

7. The furniture of claim 6 wherein:
the counterbalance weight counterbalances the weight of the panel;
the pulley is affixed to an interior of the upper housing; and
the cable is affixed to the counterbalance weight and the panel.

8. The furniture of claim 5 wherein the counterbalance system comprises a spiral balance torsion spring system.

9. The furniture of claim 8 wherein the spiral balance torsion spring system comprises at least one tube and at least one spiral rod.

10. The furniture of claim 9 wherein:
the tube is affixed to either the panel or an interior of the upper housing; and
the rod is affixed to the other of the panel or interior of the upper housing.

11. The furniture of claim 5 wherein the counterbalance system is a block and tackle counterbalance system.

12. The furniture of claim 11 wherein the block and tackle counterbalance system comprises at least one hook, at least one cable, and at least one traveling block.

13. The furniture of claim 12 wherein:
the hook is affixed to either the panel or an interior of the upper housing;
the traveling block is affixed to the other of the panel or the upper housing; and
the cable is affixed to the hook and the traveling block.

14. The furniture of claim 5 wherein the counterbalance system is a constant force coil spring system.

15. The furniture of claim 14 wherein the constant force coil spring system comprises at least one coil and at least one tape.

16. The furniture of claim 16 wherein:
the coil is affixed to either the panel or an interior of the upper housing; and
the tape is affixed to the other of the panel or the upper housing.

17. The furniture of claim 1 wherein the display stand is stationary in the furniture.

18. The furniture of claim 1 wherein the display stand is configured for attachment to a television.

19. The furniture of claim 1 wherein the furniture is a combination of a dresser and a mirrored hutch.

20. The furniture of claim 19 wherein the upper housing is the mirrored hutch and the lower housing is the dresser.

21. The furniture of claim 1 wherein the furniture is an entertainment unit.

22. The furniture of claim 1 wherein the upper housing and lower housing form a unitary case piece.

23. The furniture of claim 1 wherein the upper housing is formed by a first portion and a second portion, and wherein a position of the second portion relative to the first portion is adjustable in order to adjust a depth of the upper housing.

24. The furniture of claim 1 wherein the upper housing is configured for attachment to the lower housing such that a rear panel of the upper housing overhangs a rear panel of the lower housing.

25. Furniture comprising:
a display stand that resides in the furniture;
a panel that mechanically and vertically slides between an ascended position and a descended position in the furniture upon physical manipulation by a user; and
a counterbalance system that facilitates controlled sliding of the panel between the ascended position and the descended position;
wherein when the panel is in the ascended position, the panel substantially conceals the display stand as viewed from the front of the furniture; and
wherein when the panel is in the descended position, the display stand is substantially exposed as viewed from the front of the furniture.

26. The furniture of claim 25 wherein the counterbalance system is selected from the group consisting of a counterbalancing weight and pulley system, a spiral balance torsion spring system, a block and tackle system, and a constant force coil spring system.

27. Furniture comprising:
a display stand that resides in the furniture;
a panel that mechanically and vertically slides between a first position and a second position in the furniture upon physical manipulation by a user; and
a counterbalance system that facilitates controlled sliding of the panel between the first position and the second position;
wherein when the panel is in the first position, the panel substantially conceals the display stand as viewed from the front of the furniture; and
wherein when the panel is in the second position, the display stand is substantially exposed as viewed from the front of the furniture.
